(19) United States
(12) Patent Application Publication
(10) Pub. No.: US 2011/0311745 A1
(43) Pub. Date: Dec. 22, 2011

(54) CHEMICALLY-MODIFIED POLYBENZIMIDAZOLE MEMBRANOUS TUBES

(75) Inventors: Qian Yang, Singapore (SG); Kai Yu Wang, Singapore (SG); Tai-Shung Chung, Singapore (SG)

(73) Assignee: NATIONAL UNIVERSITY OF SINGAPORE, Singapore (SG)

(21) Appl. No.: 13/140,199

(22) PCT Filed: Dec. 15, 2009
(86) PCT No.: PCT/US2009/068098

§ 371 Date: Sep. 7, 2011

Related U.S. Application Data
(60) Provisional application No. 61/122,776, filed on Dec. 16, 2008.

(51) Int. Cl. B32B 1/08; D01D 5/24

(52) U.S. Cl. 428/36.9; 264/209.6

(57) ABSTRACT

This invention relates to a chemically-modified polybenzimidazole porous tube. The tube has an outer diameter of 100-1000 microns, a wall thickness of 20-100 microns, and a pore size of 0.1-0.5 nm.

### CROSS REFERENCE TO RELATED APPLICATIONS

This application claims the benefit of the priority of U.S. Provisional Application Ser. No. 61/122,776, filed Dec. 16, 2008, the content of which is incorporated herein by reference.

### BACKGROUND

Forward osmosis is a process that uses the osmotic pressure gradient generated by a draw solution (a highly concentrated solution) to induce water to pass through a selectively permeable membrane so as to effect separation of water from dissolved solutes.

It has been used in numerous applications, such as water reclamation, wastewater treatment, seawater desalination, concentration of liquid foods, controlled release of drugs, power generation, and water purification and reuse in space. See, e.g., T. Y. Cath, et al., J. Membr. Sci. 2006, 281: 70; J. R. McCutcheon et al., Desalination 2005, 174: 1; J. O. Kessler et al., Desalination 1976, 18: 297; K. L. Lee et al., J. Membr. Sci. 1981, 8: 141; A. Sepp\check{a}l\check{a} et al., J. Membr. Sci. 1999, 161: 115; S. Loeb, Desalination 20001, 141: 85, and T. Y. Cath et al., J. Membr. Sci. 2005, 257: 85 and T. Y. Cath et al., J. Membr. Sci. 2005, 257: 111.

There is a need for improved forward osmosis membranes, e.g., those having high ion rejection properties.

### SUMMARY

One aspect of this invention relates to a porous polybenzimidazole (PBI) tube that has a high ion rejection rate and is suitable for use in the forward osmosis process. The porous tube contains cross-linked PBI molecules, each of which includes a recurring unit of formula (I):

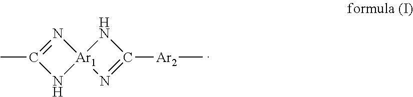

In this formula, Ar₁ is an aromatic nucleus, the four N atoms, the two C atoms, and Ar₁ together form two benzimidazole rings; and Ar₂ is a C₄₋₈ alkylene group, an aryl group, or a heterocyclic group. Examples of Ar₁ include, but are not limited to,

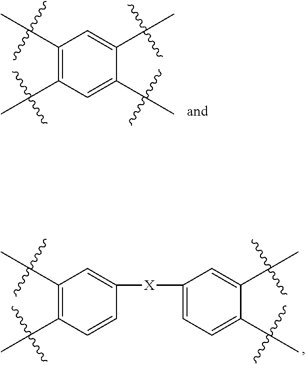

X being a bond, C₁₋₅ alkylene, O, S, or NH. Examples of Ar₂ include, but are not limited to, amylene, octamethylene, phenylene, pyridylene, pyrazinylene, furanylene, quinolinylene, thiophenylene, and pyranylene.

Preferably, the PBI tube of this invention has an outer diameter of 100-1000 microns (more preferably, 200-450 microns), a wall thickness of 20-100 microns (more preferably, 30-60 microns), and a pore size of 0.1-0.5 nm (more preferably 0.2-0.4 nm). The PBI molecules in the tube can be cross-linked with, e.g., xylene, biphenylene, naphthenylene, or anthracenylene.

The term “alkylene” refers to a straight or branched hydrocarbon, containing 1-10 carbon atoms. It may also contain one or more double bonds or triple bonds. Examples include, but are not limited to, methylene, ethylene, propylene, ethenylene, or ethynylene.

The term “aryl group” refers to a 6-carbon monocyclic, 10-carbon bicyclic, 14-carbon tricyclic aromatic ring system wherein each ring may have 1 to 4 substituents. Examples of aryl groups include, but are not limited to, phenyl, naphthyl, and anthracenyl.

The term “heterocyclylic group” refers to an aromatic or nonaromatic 5-8 membered monocyclic ring system having 1-3 heteroatoms, 8-12 membered bicyclic ring system having 1-6 heteroatoms, or 11-14 membered tricyclic ring system 1-9 heteroatoms. Heteroatoms can be O, N, S, or a combination thereof. Examples of a heterocyclylic group include pyridylene, pyrazinylene, furanylene, quinolinylene, thiophenylene, and pyranylene.

Another aspect of this invention relates to a process for fabricating a porous cross-linked PBI tube. The process includes preparing a PBI solution in a polar aprotic solvent; forming a membranous tube from the PBI solution; and contacting the membranous tube with a cross-linking agent, e.g., XH₂C—Ar₃—CH₂X in which Ar₃ is phenylene, biphenylene, naphthenylene, or anthracenylene and X is chloro, bromo, or iodo. The forming step can include extruding the PBI solution through an annular spinneret while simultaneously introducing a bore fluid into the center of the extruded PBI solution; contacting the extruded PBI solution with a coagulant to form a tubular membrane; and washing the tubular membrane with a solvent that is miscible with the polar aprotic solvent, but does not dissolve PBI.

An example of the PBI used in this method is a polymer includes a recurring unit of formula I shown above. Another example includes a recurring unit of formula II shown below:

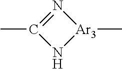

wherein Ar₃ is an aromatic nucleus, the two nitrogen atoms and the one carbon atom together form a benzimidazole ring.

The details of many embodiments of the invention are set forth in the description below. Other features, objects, and advantages of the invention will be apparent from the description and the claims.

### BRIEF DESCRIPTION OF DRAWINGS

FIG. 1. Spinning line of fabricating PBI nanofiltration hollow fiber membranes

FIG. 2. Schematic of the forward osmosis set-up and membrane orientations

FIG. 3. Morphology of an asymmetric PBI hollow fiber membrane

FIG. 4. Pore size distribution probability density of the PBI hollow fibers

FIG. 5. Salt rejections by the PBI nanofiltration hollow fiber membranes during nanofiltration

FIG. 6. Effect of draw solution concentration on the water permeation flux under different membrane orientations

FIG. 7. Effect of temperature on the water permeation flux during forward osmosis

### DETAILED DESCRIPTION

PBI is a generic name for a class of polymers containing benzimidazole moieties. Examples of PBI having the recurring structure of Formula (I) include: poly-2,2′-(m-phenylene)-5,5′-bibenzimidazole; poly-2,2′-(pyridylene-3″,5″)-5,5′-bibenzimidazole; poly-2,2′-amylene-5,5′-bibenzimidazole; poly-2,6-(m-phenylene)-diimidazolbenzene; poly-2,2′-cyclohexenyl-5,5′-bibenzimidazole; poly-2,2′-(furylene-2″,5″)-5,5′-bibenzimidazole; poly-2,2′-(naphthalene-1″,6″)-5,5′-bibenzimidazole; poly-2,2′-(biphenylene-4″,4″)-5,5′-bibenzimidazole; poly-2,2′-octamethylene-5,5′-bibenzimidazole; poly-2,2′-(m-phenylene)-5,5′-di(benzimidazole)ether; poly-2,2′-(m-phenylene)-5,5′-di(benzimidazole)sulfide; poly-2,2′-(m-phenylene)-5,5′-di(benzimidazole)sulfone; poly-2,2′-(m-phenylene)-5,5′-di(benzimidazole)methane; poly-2,2′-(m-phenylene)-5′,5″-di(benzimidazole)propane-2,2; and poly-2′,2″-(m-phenylene)-5′,5″-di(benzimidazole)ethylene-1,2.

Typical process for preparing PBI are described in Handbook of Thermoplastics, O. Olabisi ed., Marcel Dekker, New York, 1997, 701; and U.S. Pat. No. 2,895,948; and U.S. Pat. Re. 26,065. For example, the PBI of formula (I) can be prepared by condensing (i) an aromatic tetraamine compound containing a pair of orthodiamino substituents on the aromatic nucleus with (ii) a dicarboxylic compound selected from the class consisting of (a) the diphenyl ester of an aromatic dicarboxylic acid, (b) the diphenyl ester of a heterocyclic dicarboxylic acid wherein the carboxyl groups are substituents upon a carbon in a heterocyclic ring compound selected from the class consisting of pyridine, pyrazine, furan, quinoline, thiophene, and pyran, and (c) an anhydride of an aromatic dicarboxylic acid.

The preferred PBI for use in this invention is prepared from poly-2,2′-(m-phenylene)-5,5′-bibenzimidazole shown below:

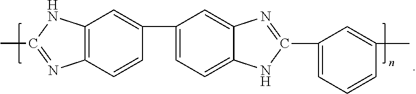

This PBI has the inherent viscosity (IV) between 0.7 and 0.75 dL/g measured at 0.4 wt % concentration in 97% sulfuric acid, the glass transition temperature (Tg) of 425° C.-435° C.

### Preparation of a PBI Solution

Polar aprotic solvents are utilized to form a PBI solution. Examples of polar aprotic solvents include N,N-dimethylacetamide (DMAc), dimethyl sulfoxide, dimethyl formamide, and N-methyl-pyrrolidinone. The solution may contain lithium chloride (0.5-5 wt %), which serves the function of preventing PBI from phasing out of the solution. A preferred spinning solution for fabricating PBI nanofiltration membrane contains about 15 to 26 percent by weight the PBI. The spinning solution preferably exhibits a viscosity of about 100 to 3000 poises measured at 25° C., and most preferably a viscosity of about 200 to 1000 poises measured at 25° C.

### Formation of a PBI Porous Tube

A PBI solution is preferably provided at a temperature of about 5 to 100° C., at the time of spinning, and most preferably at the temperature range of about 20 to 50° C. The PBI solution firstly flows through a filter (mesh size of 15 μm) and is extruded an annular spinneret with concentric orifices while simultaneously introducing a bore fluid into the center of the extruded PBI solution, and then dips into a coagulant to take phase inversion. The dimensions of the spinneret are preferably such that the outer diameter of the resulting extrusion orifice through which the PBI solution passes is about 0.5 to 2.5 mm, and most preferably about 0.75 to 1.5 mm. The inner diameter of the extrusion orifice through which the bore fluid solution passes is preferably about 0.3 to 2 mm, and most preferably about 0.3 to 1.0 mm. The commercially available concentric spinnerets used in industry may include one or many appropriate extrusion orifices. When the polymer solution is extruded from the spinneret, a bore fluid solution is continuously introduced through the spinneret into the center portion of the extruded polymer solution. See FIG. 1. The bore fluid solution is preferably miscible with the solvent for PBI and the coagulant of PBI. It can be a mixture of the polar aprotic solvent for PBI and another solvent selected from ethylene glycol, diethylene glycol, glycerol, and propylene glycol. Other examples for a bore fluid solution include water, DMAc/water mixture, ethylene glycol, ethylene glycol/water mixture, and DMAc/ethylene glycol mixture. The volume flow rates of PBI solution and bore fluid solution through the spinneret are about 0.1 to 10 ml/min.

The PBI solution is preferably extruded into a gaseous atmosphere (e.g., air, nitrogen, or carbon dioxide, or helium at the ambient temperature) prior to contact with a coagulant bath. Dry-jet wet spinning is utilized to stretch the fiber and control its dimension and subsequent separation performance. The stretching along a spinning line is conducted at a speed of approximately 15 meter/min to 75 meter/min. There is preferably an air gap (between the spinneret outlet and the top surface of the coagulation bath) of about 0.5 to 50 cm, and most preferably about 0.5 to 5.0 cm. Such positioning of a spinneret facilitates the implementation of a substantial extra stretching of the extruded PBI solution prior to coagulation.

The extruded PBI solution is coagulated to form a hollow fiber membrane by contacting exterior surface with a coagulant, i.e., a solvent which is miscible with the polar aprotic solvent, but does not dissolve PBI. Preferred coagulants are water, ethylene glycol, mixture of ethylene glycol/water, mixture of water and glycerol, mixture of N,N-dimethylacetamide, and mixture of ethylene glycol/DMAc. Other preventative coagulant solvents for PBI may include glycerine, methanol, ethanol, isopropanol, and their mixture with water. In a particularly preferred embodiment of the phase inversion process, the coagulant is carried out by contact with water. The temperature of coagulant bath is preferably about 0 to 90° C., and most preferably about 20 to 35° C. The exposure of the PBI solution containing of bore fluid solution to the coagulant bath is preferably at least 0.5 second, and most preferably about 1 to 5 seconds.

The formed PBI tubular fiber membranes are washed with a liquid which is miscible with DMAc to remove residual solvent. Preferred wash solutions include water, glycerol, ethylene glycol, mixtures of glycerol/water and mixtures of ethylene glycol/water. Other representative wash solutions include methanol, ethanol, 1-propanol, isopropanol, and their aqueous solutions. The most preferred process is washing the resulting PBI tubular fibers with flowing water or dipping in water for 3 to 5 days to remove residual solvent. The wash solution is preferably provided at a temperature of 5 to 50° C., and most preferably about 20 to 30° C.

The resulting PBI tubular fiber membranes have a selective outer layer surface which is relatively adjacent a more porous internal sponge-like structure. The PBI hollow fibers produced in the present process have an outer diameter of about 100 to 1000 microns, an inner diameter of 60 to 800 microns, and a wall thickness of 20-100 microns. The particularly preferred PBI hollow fibers produced in the present process have an outer diameter of about 200 to 450 microns, and a wall thickness of about 30 to 60 microns. The hollow fibers exhibit a high degree of chemical stability and can continue to function in spite of contact with a wide variety of organic solvents and under a wide range of pH.

### Chemical Modification

The PBI membrane is chemically modified to form a PBI nano-porous membrane.

According to the process of the present invention, the composite PBI membrane is modified by contacting the membrane with a cross-linking agent, e.g., dihalo-p-xylene as shown below:

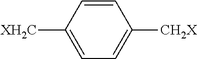

wherein X is halo, e.g., Cl, F, or Br, preferably p-xylylene dichloride:

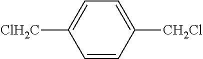

When an asymmetric nano-porous PBI membrane, that is, a membrane having a thin skin superimposed upon a porous support layer, is contacted with a substituting agent, such as p-xylylene dichloride, it is possible that the substitution may influence the network structure of the asymmetric membrane. Therefore, it is preferred that asymmetric membranes be modified by a controlled substitution process through contacting such membranes with p-xylylene dichloride at a low concentration.

In addition, the water in the PBI membrane must be removed by solvent exchange using other solvents before modification. For example, dipping the as-PBI membrane in fresh methanol, ethanol, or isopropanol, which is miscible with water, then re-immersing the membrane in the solvent for the sulfonation agent for several times to minimize residual water.

The PBI porous membrane is contacted with the cross-linking agent solution described above under stirring at a temperature within the range of approximately 5° C. to 100° C. The contacting temperature is preferably within the range of approximately 15° C. to 60° C., and is most preferably within the range of approximately 20° C. to 50° C.

The time for the cross-linking may be short, e.g., approximately 30 minutes. Preferably, the membrane is contacted with the cross-linking agent for a period of time within the range of approximately 0.5 to 48 hours, and, more preferably, for a period of time of approximately 2 to 12 hours. Although the chemically modification reaction is essentially instantaneous, the contact time given above ensures that the reagent penetrates the interior of the porous membrane.

The thus-obtained PBI tubes contain pores having a size of which is 0.1-0.5 nm (or 0.2-0.4 nm).

To clean the cross-linked PBI tubes, they are washed with a solvent selected from methanol, ethanol, 1-propanol, isopropanol, or a mixture thereof. After washing, they are soaked in the glycerol/water solution, then air-dried for use.

The separation capabilities of the cross-linked PBI tubes produced in accordance with the process of the present invention can be improved further by higher degrees of substitution which may be achieved by repeating the process of the present invention one or more times. However, for most purposes, a single contacting treatment is sufficient to produce nanofiltration membranes exhibiting desirable separation performance.

### Characterization Through the Solute Separation Measurements

The PBI tubular fiber samples are conducted for solute separation experiments through filtering different solutions, containing neutral solutes, inorganic salts, and binary salt mixtures. The solute separation coefficient R (%) was calculated by using the following equation:

$$R = ( 1 - \frac{{C}_{permeate}}{{C}_{feed}} ) \times 100$$

where Cₚₑᵣₘₑₐₜₑ and C_{feed} are the solute concentration in the permeate and the feed solution, respectively. The mean effective pore size and the pore size distribution can be obtained from the solute rejection data.

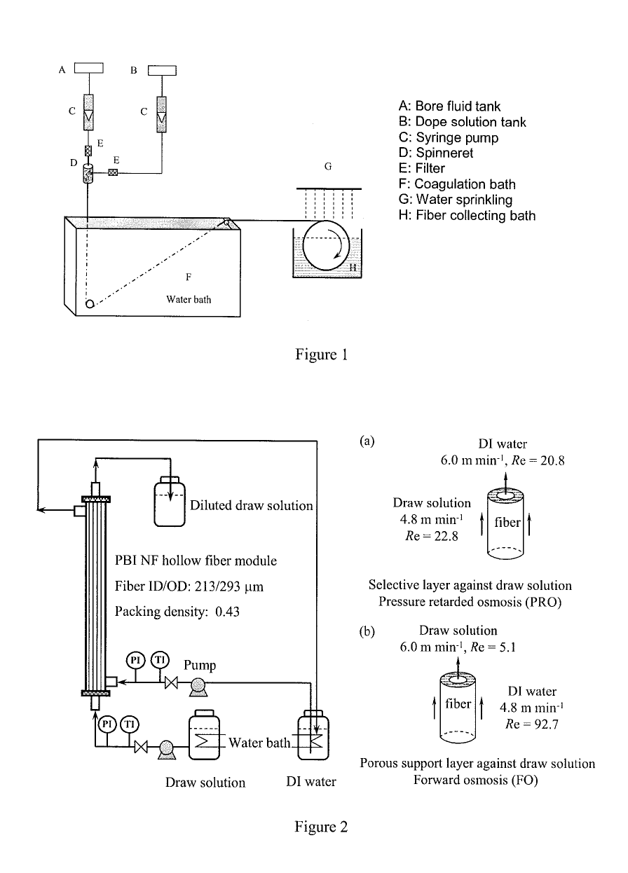

Each hollow fiber membrane module has a filtration area of about 300 cm². The flowing channels for the draw solution and feed solution (DI water) inside the membrane module can be interchanged in order to test the effects of flow pattern and membrane structure on water permeation flux. The draw solution and DI water co-currently flowed through the module and were maintained at the same temperature by the water bath. The concentration of draw solution was always kept constant during operation whereas the DI water in the other side circulated. Water permeation flux was calculated from the weight changes of draw solution and DI water. Salt rejection by the membrane was calculated from the concentration of salt in the DI water which permeating from draw solution. Forward osmosis experiments were conducted on a lab-scale circulating filtration unit, as shown in FIG. 2. Two kinds of flowing patterns are employed to test the membrane performance during forward osmosis: namely, the pressure retarded osmosis (PRO) mode for when the draw solution flows against the selective layer, and the FO mode for when the draw solution flows against the porous support layer.

The examples below are to be construed as merely illustrative, and not limitative of the remainder of the disclosure in any way whatsoever. Without further elaboration, it is believed that one skilled in the art can, based on the description herein, utilize the present invention to its fullest extent. All publications, including US patents, cited herein are hereby incorporated by reference in their entirety.

### Example I

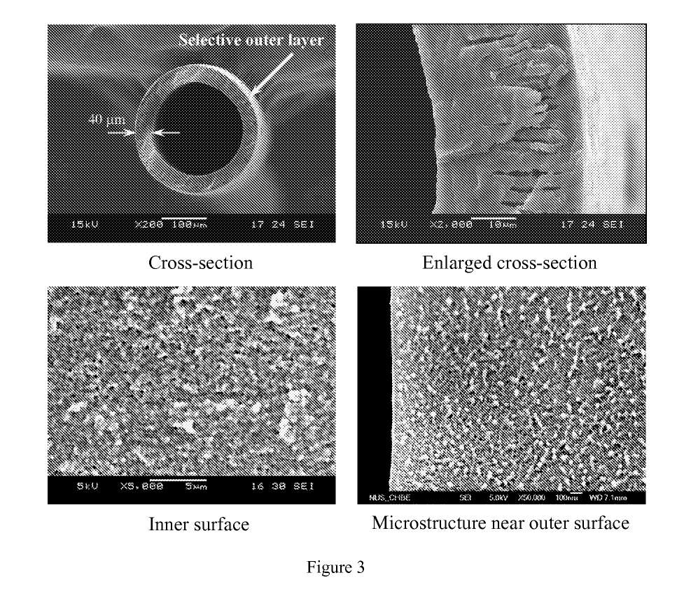

A PBI solution was provided from Hoechst Colanese Corporation, Somerville, N.J., which have the composition of PBI 25.6 wt %, DMAc 72.4 wt %, and LiCl 2.0 wt %. The intrinsic viscosity was about 0.70 to 0.75 dL/g. It was diluted with DMAc to one having PBI 22.0 wt %, DMAc 76.3 wt %, and LiCl 1.7 wt %. The PBI solution was loaded in the syringe pump and fed to an annular spinneret. A bore fluid solution containing DMAc and ethylene glycol 50/50 wt % was loaded in another syringe pump and fed to the inner orifice of the annular spinneret. The outer diameter of the extrusion orifice through which the polymer solution was supplied was 1.6 mm, and the inner diameter of extrusion orifice through which the bore fluid solution passed was 0.66 mm. The flow rates of PBI spinning solution and the bore fluid solution were both 3.0 ml min⁻¹. Both the temperatures of the PBI spinning solution and the bore fluid solution were kept at about 26° C. An extraneous longitudinal extension was exerted on the extruded solution at the drawing speed of 39.2 m min⁻¹. A water coagulation bath was used to induce phase inversion at the ambient temperature of about 26° C. The outlet of spinneret was mounted 1.0 cm above the top level of the coagulation bath. The formed PBI hollow fiber membranes were dipped in water for 3 days to remove the residual solvent. The outer and inner diameters of the formed fiber are 293 and 213 microns, respectively. SEM images of the freeze dried hollow fiber membrane are shown in FIG. 3.

### Example II

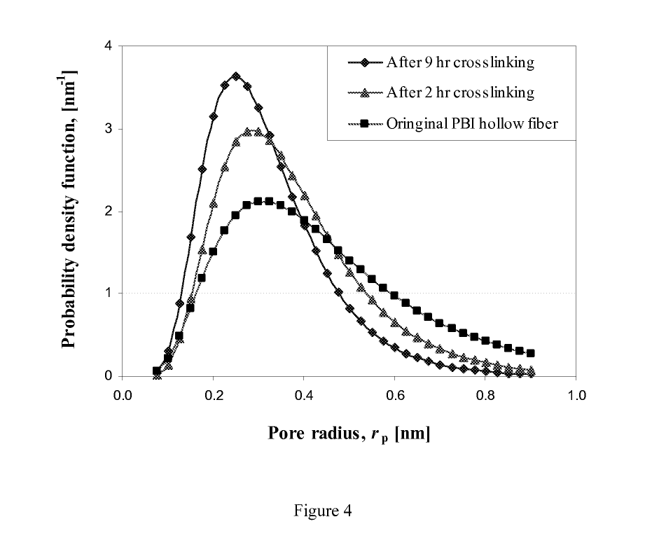

The PBI hollow fiber membrane prepared in Example I was dipped in fresh methanol for three times to remove water. Then, it was dipped in a solution of p-xylylene dichloride (1.0 wt %) in ethanol for 2.0 and 9.0 hours. After taken out of the p-xylylene dichloride solution, the modified PBI membrane was rinsed with ethanol again, and then kept in water. Solute transport experiments were conducted to characterize the pore size distribution. More specifically, 200 ppm solutions containing glycerol, glucose, saccharose or raffinose with known Stokes radius rₛ were used to measure the solute rejection. The pore size distribution probability density curve of the PBI membranes calculated is represented in FIG. 4. As shown in this figure, the chemically modified PBI tubes had narrower pore size distribution than non-modified PBI tubes.

Following table depicts the pure water permeability, mean pore size and molecular weight cut-off (MWCO) of the PBI membrane as a function of modifying period in the p-Xylylene dichloride/ethanol solution.

| | PWP | rₚ | MWCO |
|---|---|---|---|
| PBI membranes (B) | (1 m⁻² bar⁻¹ hr⁻¹) | (nm) | (Da) |
| Original membrane | 2.43 | 0.41 | 993 |
| Modified membrane (2 hour) | 1.53 | 0.34 | 528 |
| Modified membrane (9 hour) | 1.25 | 0.29 | 354 |

The 2-hr modified PBI nanofiltration membrane with high permeation flux and improved salt selectivity may be used for water recovery from wastewater whereas a longer cross-linking time, 9 hr, may make the PBI membrane applicable for the seawater desalination.

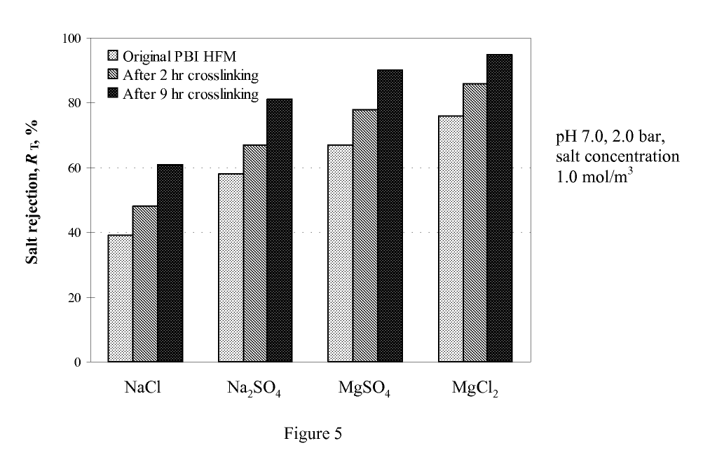

FIG. 5 shows that the PBI membranes exhibit high rejection to cations, especially to divalent cations. After chemical modification, the salt rejection is increased along with the increase of the modification period.

### Example III

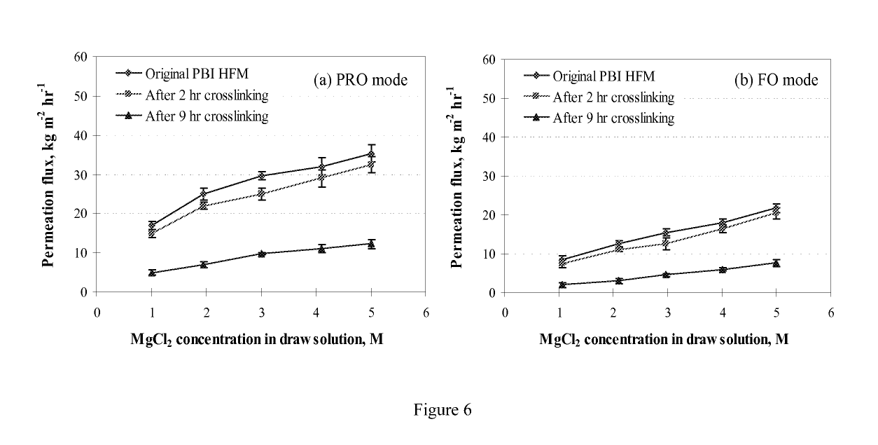

The effect of the draw solution concentration on the water permeation flux was tested at 22.5° C. MgCl₂ solutions of different concentrations were used as the draw solutions. Two different flowing modes, i.e., pressure retarded osmosis (PRO) and forward osmosis (FO), were tested. The results are shown in FIG. 6. The draw solution concentration dominated the membrane performance, as the osmotic pressure was the driving force in the FO process. When the draw solution flowed through the shell side of the hollow fiber, the resultant water permeation was much higher than the opposite (where the draw solution flowed through the lumen side). This is due to the internal dilutive concentration polarization within the porous inner structure of asymmetric membrane.

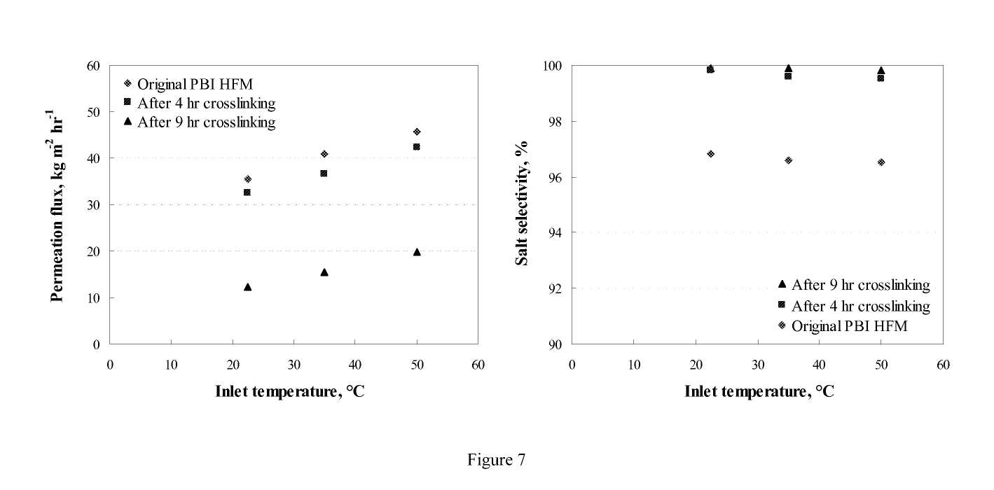

Effect of temperature on the water permeation flux was also examined. FIG. 7 shows that, as the inlet temperature increased, the permeation flux also increased while the salt selectivity slightly decreased.

### Other Embodiments

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features.

From the above description, one skilled in the art can easily ascertain the essential characteristics of the present invention, and without departing from the spirit and scope thereof, can make various changes and modifications of the invention to adapt it to various usages and conditions. For example, compounds structurally analogous to the compounds of this invention can be made and used to practice this invention. Thus, other embodiments are also within the claims.

What is claimed is:

1. A porous tube comprising cross-linked polybenzimidazole molecules, each of which includes a recurring unit of formula (I), 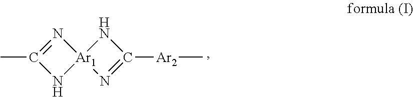
wherein
Ar₁ is an aromatic nucleus,
the four N atoms, the two C atoms, and Ar₁ together form two benzimidazole rings; and
Ar₂ is a C₄₋₈ alkylene group, an aryl group, or a heterocyclic group.

2. The tube of claim 1, wherein Ar₁ is 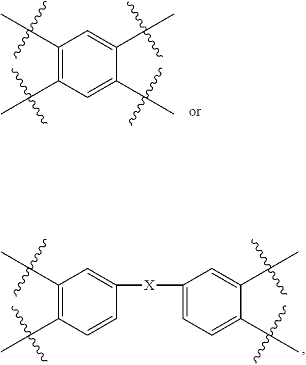
being a bond, C₁₋₅ alkylene, O, S, or NH.

3. The tube of claim 2, wherein Ar₂ is amylene, octamethylene, phenylene, pyridylene, pyrazinylene, furanylene, quinolinylene, thiophenylene, or pyranylene.

4. The tube of claim 3, wherein the polybenzimidazole molecules are cross-linked with a cross-linking moiety selected from a group consisting of xylene, biphenylene, naphthenylene, and anthracenylene.

5. The tube of claim 4, wherein the cross-linking moiety is p-xylene.

6. The tube of claim 1, wherein Ar₁ is 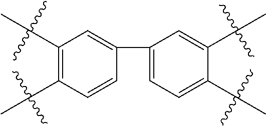
and Ar₂ is phenylene.

7. The tube of claim 6, wherein the tube has an outer diameter of 200-450 microns, a wall thickness of 30-60 microns, and a pore size of 0.2-0.4 nm.

8. The tube of claim 1, wherein Ar₂ is amylene, octamethylene, phenylene, pyridylene, pyrazinylene, furylene, quinolinylene, thiophenylene, or pyranylene.

9. The tube of claim 8, wherein the polybenzimidazole molecules are cross-linked with a moiety selected from a group consisting of xylene, biphenylene, and naphthenylene.

10. The tube of claim 1, wherein the polymers are cross-linked with a moiety selected from a group consisting of xylene, biphenylene, and naphthenylene.

11. The tube of claim 1, wherein the tube has an outer diameter of 100-1000 microns, a wall thickness of 20-100 microns, and a pore size of 0.1-0.5 nm.

12. The tube of claim 11, wherein the outer diameter is 200-450 microns.

13. The tube of claim 11, wherein the wall thickness is 30-60 microns.

14. The tube of claim 11, wherein the pore size is 0.2-0.4 nm.

15. The tube of claim 11, wherein the outer diameter is 200-450 microns, the wall thickness is 30-60 microns, and the pore size of 0.2-0.4 nm.

16. A process for fabricating a porous cross-linked polybenzimidazole tube, the process comprising:
preparing a polybenzimidazole solution in a polar aprotic solvent;
forming a membranous tube from the polybenzimidazole solution; and
contacting the membranous tube with a cross-linking agent.

17. The process of claim 16, wherein the benzimidazole is of formula (I): 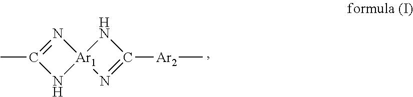
wherein
Ar₁ is an aromatic nucleus,
the four N atoms, the two C atoms, and Arₜ together form two benzimidazole rings; and
Ar₂ is a C₄₋₈ alkylene group, an aryl group, or a heterocyclic group.

18. The process of claim 17, wherein Ar₁ is 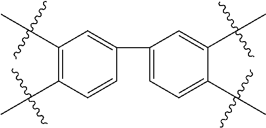
and Ar₂ is phenylene.

19. The process of claim 18, wherein the bore fluid is a mixture of a polar aprotic solvent and another solvent selected from the groups consisting of ethylene glycol, diethylene glycol, glycerol, and propylene glycol.

20. The process of claim 16, wherein the cross-linking agent is a compound of the following formula:
XH₂C—Ar₃—CH₂X,
wherein Ar₃ is phenylene, biphenylene, naphthenylene, or anthracenylene and X is chloro, bromo, or iodo.

21. The process of claim 20, wherein the cross-linking agent is a compound of the following formula: 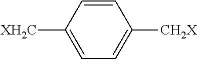
wherein X is chloro, bromo, or iodo.

22. The process of claim 16, wherein the forming step includes:
extruding the polybenzimidazole solution through an annular spinneret while simultaneously introducing a bore fluid into the center of the extruded polybenzimidazole solution;
contacting the extruded polybenzimidazole solution with a coagulant to form a tubular membrane; and
washing the tubular membrane with a solvent that is miscible with the polar aprotic solvent, but does not dissolve polybenzimidazole.

23. The process of claim 22, wherein the benzimidazole is of the following formula: 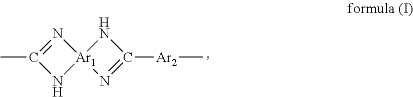
wherein
Ar₁ is an aromatic nucleus,
the four N atoms, the two C atoms, and Ar₁ together form two benzimidazole rings; and
Ar₂ is a C₄₋₈ alkylene group, an aryl group, or a heterocyclic group.

24. The process of claim 23, wherein Ar₁ is 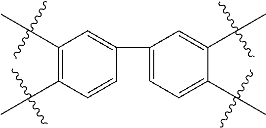
and Ar₂ is phenylene.

25. The process of claim 24, wherein the coagulant is selected from a group consisting of water, glycerol, ethylene glycol, N,N-dimethylacetamide, methanol, ethanol, isopropanol, and a mixture thereof.

26. The process of claim 22, wherein the bore fluid is introduced to the center of the extruded polybenzimidazole solution by passing through an orifice having a diameter of 0.3-2 mm.

27. The process of claim 22, wherein the annular spinneret is placed 0.5-50 cm above the coagulant.

28. The process of claim 22, wherein the cross-linking agent is a compound of the following formula: 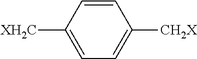
wherein x is chloro, bromo, or iodo.
